(19) United States
(12) Patent Application Publication
(10) Pub. No.: US 2012/0000334 A1
(43) Pub. Date: Jan. 5, 2012

(54) Tool holder device for shearing machine

(75) Inventor: Attilio Cavagna, Galgagnano (LO) (IT)

(73) Assignee: Elio Cavagna S.R.L., Galgagnano (LO) (IT)

(21) Appl. No.: 13/134,709

(22) Filed: Jun. 15, 2011

(30) Foreign Application Priority Data
Jun. 30, 2010 (IT) MI2010A001180

(51) Int. Cl. B26D 7/26

(52) U.S. Cl. 83/522.24

(57) ABSTRACT

A tool holder (10, 10′) for shearing machines, especially of the longitudinal type, suitable for processing on paper, cardboard, plastic films, various laminates, aluminium, fabric, non woven, fibreglass, carbon fibre and the like, including a blade holder head provided with a preferably circular blade (12), partially protected by a casing (14) and rotatably connected to an elastically deformable arm (16) and to a bar (18) sliding according to a vertical direction, a further protection element for the same blade defined by a shaped plate (20) provided with a through opening (22), at least one piston (30, 32) for the up/down movement of the blade holder, with said bar (18) and said at least one piston (30, 32) arranged and moved in a chamber (23) of a support body (24), the tool holder further includes an element suitable for allowing an anti-rotation of the bar (18) with zero clearance, an adjustment of the shearing angle, an axial adjustment of the same bar and of the down stroke of the tool or blade (12).

The present invention relates to a tool holder device for shearing machines.

More in particular, the present invention relates to a tool holder device for shearing machines especially of the longitudinal type, suitable for working on paper, cardboard, plastic films, various coupled materials, aluminium, fabric, non woven, glass fibre, carbon fibre and similar.

As is known, the shearing machines of the longitudinal type perform the shearing of the material employing the “scissor”, pressure or blade technique; the different shearing techniques are selected in function of the thickness of the material to be sheared and of the speed of execution of the process.

Said machines shear the material by means of shearing elements, called “knives”, defined by circular blades or by single shearing elements/blades generally mounted on circular disks and rotatably included in a tool holder or blade holder device.

The blade or knife is set in rotation by a sliding/friction action with a motor-driven counter blade substantially opposite the same blade and with said blade connected to a support that may be positioned shifting-wise along a bar or the like; the blade positioning relative to the bar as well as the lowering of the same blade during the shearing operating step is typically actuated automatically with pneumatic drives.

Moreover, in order to carry out an error-free longitudinal shearing of the product and such as to ensure a high quality of the end product, it is necessary to prevent any clearance of the bar whereon the blade or knife is mounted; in fact, such clearance causes a variation in the blade position, with a consequent shearing affected by errors and therefore of very poor quality.

Some traditional tool holder devices obtain the anti-rotation by a key that, mounted at the bar, only allows the shifting movement thereof. However, this construction solution has the drawback of causing the component wear, due to the relative friction between the contacting surfaces, with consequent appearance of clearances that are responsible for the presence of errors on the products subject to the shearing process.

In order to try to obviate the above drawback, other devices use a broached bar. However, also this construction solution exhibits some important drawbacks related to the expensiveness of the same structure (considering that the bar broaching process is quite expensive) and to the impossibility of adjusting the shearing angle by directly acting on the bar.

Other known embodiment solutions exhibit a configuration with a fixed shearing angle, with the drawback represented by the fact that the replacement of some component elements is required to change the shearing angle.

EP0562454, for example, describes a strip shearing unit of preferably paper material, provided with means for controlling the blade rotation in an angular range comprised between 0 and 90°. Said means are defined by a flanged bushing fixed to a support body, axially whereto there is arranged a shaft rotatably locked by a key integral to the shaft through screws and by a plate-shaped element constrained to the support body and suitable for tightening the shaft imposing torsional stiffness; by loosening the tightening screw of the plate-shaped element it is possible to release the shaft and allow the adjustment rotation thereof by acting on a flange or on an adjustment screw that engages with a toothed wheel applied inside the plate-shaped element and coaxially to the shaft.

The object of the present invention is to obviate the drawbacks discussed hereinabove.

More in particular, the object of the present invention is to provide a tool holder device for shearing machines that allows easily adjusting the shearing angle preventing the risk of occurrence of clearances that would cause errors on the material being processed and thus a consequent poor shearing quality.

A further object of the present invention is to provide a tool holder device that allows a quick and easy adjustment of the blade and shearing angle position relative to the product being processed without the need of replacing component elements of the device.

A further object of the present invention is to provide a tool holder device for shearing machines suitable for ensuring a high level of resistance and reliability over time and moreover, also such as to be easily and inexpensively constructed.

These and other objects are achieved by the tool holder device for shearing machines of the present invention which comprises a blade holder head provided with a preferably circular blade, partially protected by a casing and rotatably connected to an elastically deformable arm and to a bar sliding according to a vertical direction, a further protection element for the same blade defined by a shaped plate provided with a through opening, at least one piston for the up/down movement of the blade holder, with said bar and said at least one piston arranged and moved in a chamber of a support body, the tool holder device that further comprises means suitable for allowing an anti-rotation of the bar with zero clearance, an adjustment of the shearing angle, an axial adjustment of the same bar and of the down stroke of the tool or blade.

The construction and functional features of the tool holder device for shearing machines of the present invention shall be better understood from the following detailed description, wherein reference is made to the annexed drawings showing a preferred and non-limiting embodiment thereof, and wherein:

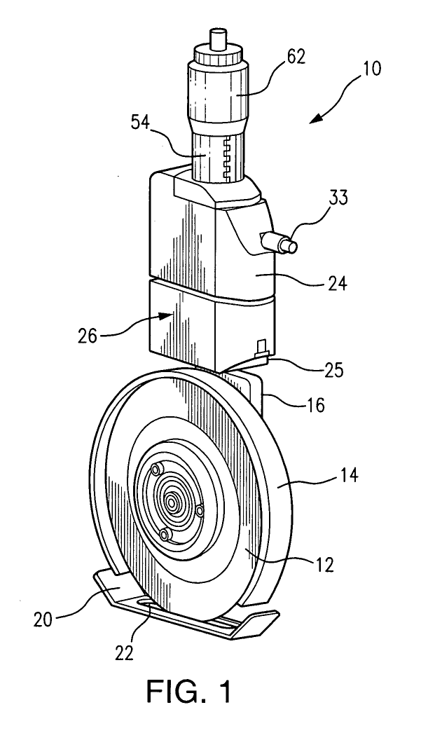

FIG. 1 shows a schematic and axonometric view of the tool holder device for shearing machines of the present invention;

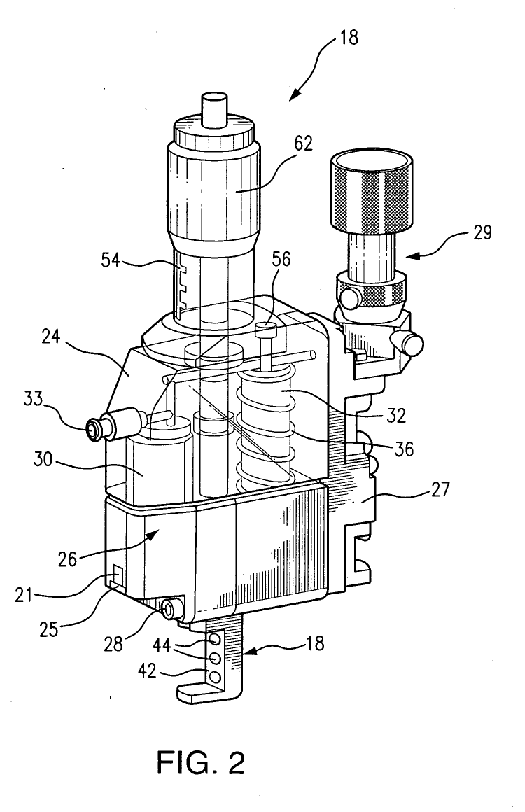

FIG. 2 shows a schematic axonometric view showing the inside components of the tool holder device of the invention;

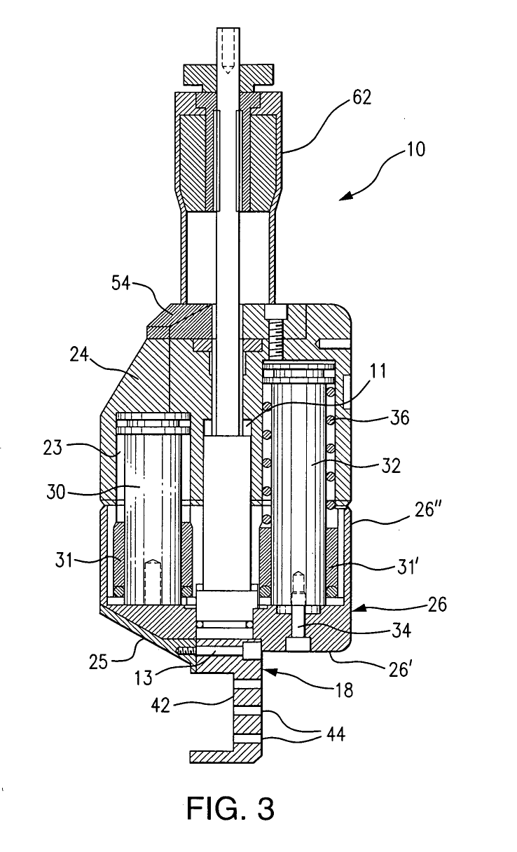

FIG. 3 shows a longitudinal cutaway schematic view of the device of the invention;

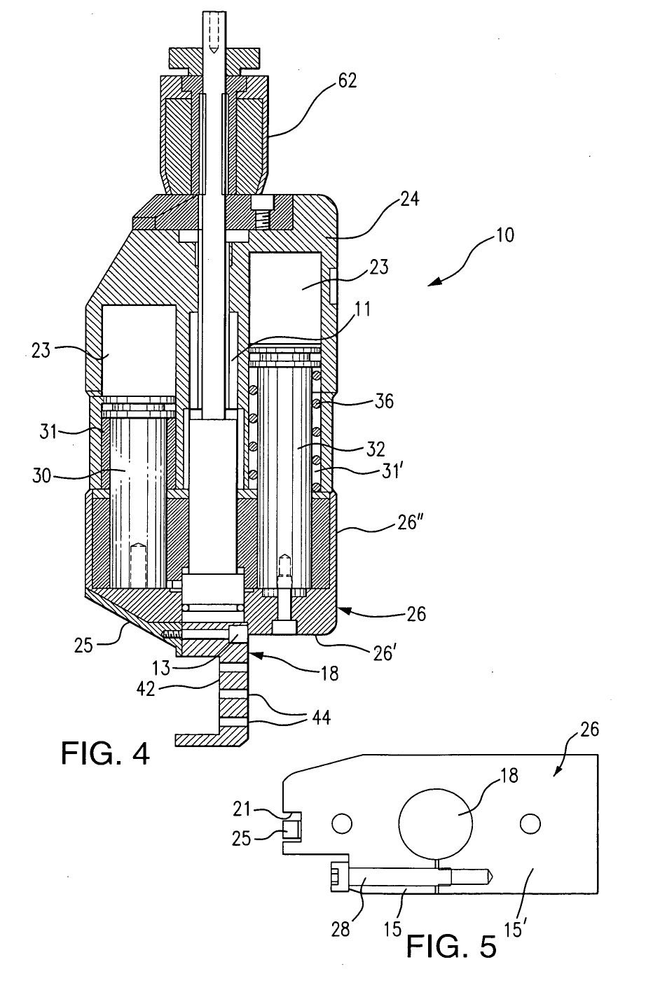

FIG. 4 shows a longitudinal cutaway schematic view of the device of the invention in operating step;

FIG. 5 schematically shows a cross section of the tool holder device of the invention;

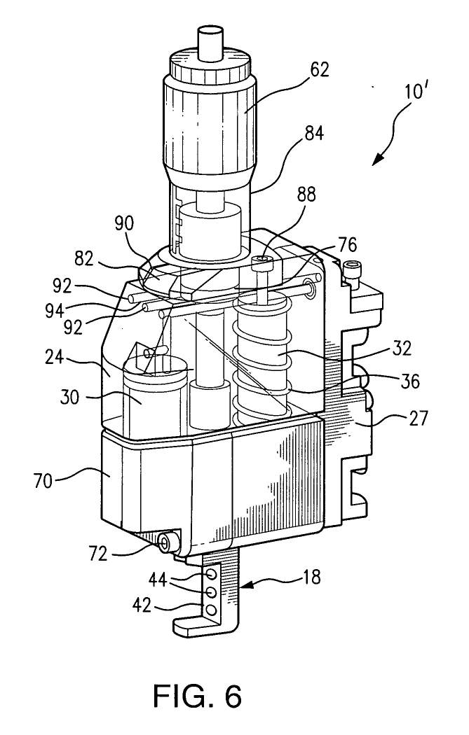

FIG. 6 shows a schematic axonometric view showing the inside components of the tool holder device of the invention according to an alternative embodiment;

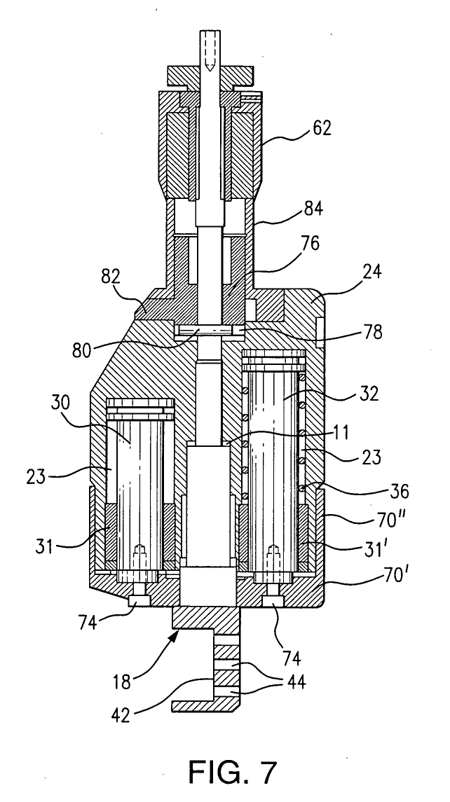

FIG. 7 shows a longitudinal cutaway schematic view of the alternative embodiment of the device of the invention;

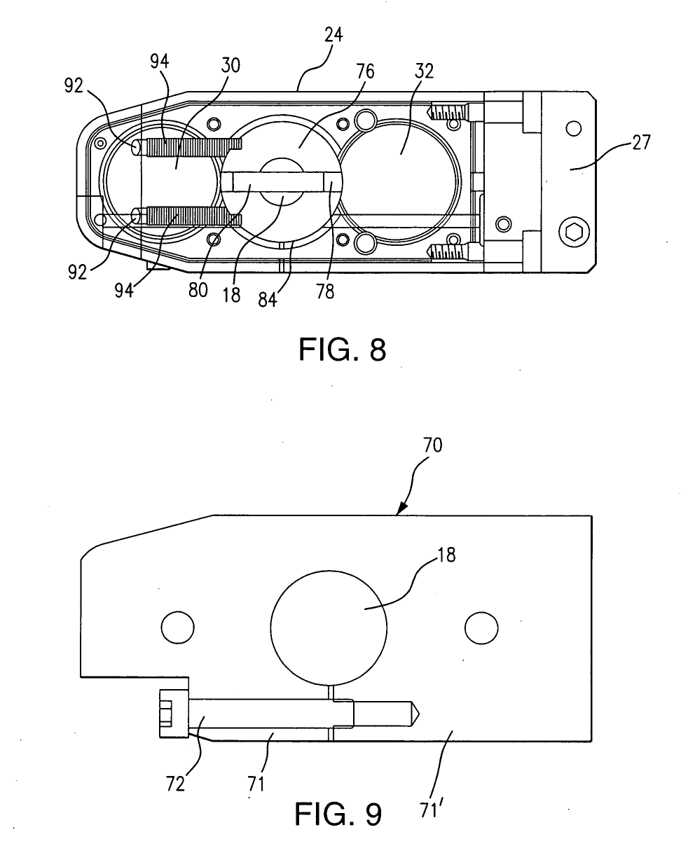

FIG. 8 shows a cross section of the tool holder device of the invention according to the alternative embodiment;

FIG. 9 schematically shows a further cross section of the same alternative embodiment.

With reference to said figures, the tool holder device for shearing machines of the present invention, globally indicated with reference numeral 10 in the figures, comprises a blade holder head provided with a preferably circular blade 12, partially protected by a casing 14, rotatably connected to an elastically deformable arm 16 and to a bar 18 sliding according to the vertical direction and described in detail hereinafter.

Underneath blade 12 there is arranged a further protection element for the same blade defined by a shaped plate 20 provided with a through opening 22 made at blade 12 to allow the partial passage thereof.

Bar 18 is slidingly arranged within a chamber 11 obtained in a support body 24 suitable for seating further component elements of the device that shall be described hereinafter.

Said support body 24 is closed at the bottom by a cover 26 defined by a base or bottom 26′ from the top front whereof a collar 26″ develops, according to a vertical direction and along the perimeter thereof, which externally circumscribes a bottom portion of the support body 24.

With particular reference to FIG. 5, cover 26 partly circumscribes bar 18 which may be made torsionally integral to said cover by approaching two portions 15 and 15′ not matching of the same cover by the tightening action of a screw 28 or an equivalent means suitable for performing the same function.

In the front portion thereof, said cover 26 exhibits a pocket 21 wherein a lever 25 is movable according to a horizontal plane, fixed by a screw 13 or by other retaining means to bar 18 and suitable for allowing an angular adjustment of the same bar prior to the tightening thereof.

The support body 24, moreover, is constrained to a plate 27 for connecting the tool holder device to the structure (not shown in the figure) of the shearing machine; said plate 27 is provided with adjustment means 29 suitable for varying the position of the tool holder device relative to the shearing machine.

Since such adjustment means are of the traditional type, they shall not be described in detail with reference to the structural and constituent components thereof.

The support body 24 internally exhibits at least one further chamber 23 suitable for seating and allowing the sliding of a piston or of an equally known linear actuating means; in the preferred embodiment schematised in the figures, the support body is provided with two chambers 23 wherein there are arranged a first piston 30 and a second piston 32 stabilised to the base or bottom 26′ of cover 26 by screws 34 or other known removable constraining means. In this way, cover 26 is only stabilised relative to said piston and is sliding, according to the methods described hereinafter, relative to the support body 24.

The first piston 30 and the second piston 32 preferably are of the anti-rotation type with pneumatic actuation (the compressed air is injected through a union 33 integral to the support body 24), they are sliding relative to bushings 31 and 31′ and may be provided with an optional elastic element, defined by a helical spring 36 with the function of allowing an elastic return.

Said first piston 30 and second piston 32 cause the up/down movement of the blade holder relative to the product to be subject to shearing process.

FIGS. 3 and 4 respectively show the step wherein pistons 30 and 32 are in rest condition with bar 18 in “0” position and the step of maximum extraction or stroke of the same bar 18, with cover 26 that slides relative to the support body 24.

As mentioned before, bar 18 is slidingly arranged within chamber 11 obtained in the support body 24 protruding from the same by a top and bottom end portion.

The bottom end portion of bar 18 extends in an appendix 42 shaped as an “L” and provided with one or more holes 44 suitable for allowing the constraint and the support of the elastically deformable arm 16 the blade or knife 12 is connected to.

The top end portion of bar 18 protruding from the support body 24 into a flanged adjustment bushing 54 and stabilised to the top front of the support body 24 by screws 56 or other known constraining means.

A graduated scale is made or applied on the outer side surface of said adjustment bushing 54 which has the function of allowing the adjustment described hereinafter by a traditional adjustment means defined by a vernier scale 62 fitted and axially sliding relative to the adjustment bushing 54.

By manually acting on the vernier scale 62, by a wrench or other known means, the vertical (axial) position of bar 18 is precisely adjusted so as to allow the adjustment of the down stroke of the shearing tool or blade 12.

The thrust action of pistons 30 and 32, by the effect of the compressed air injected through union 33, causes the down movement of cover 26 and consequently of blade 12, as schematised in FIG. 4.

Such movement may also be performed automatically using motor drives such as, for example, electrical linear stepping motors; likewise, the adjustment of the vertical position of bar 18 may be obtained automatically by an electrical motor applied to the vernier scale 62.

With reference to FIGS. 6 to 9, there is shown an alternative embodiment 10′ of the device of the invention; the details common to the two embodiments are indicated with the same reference numerals and are not described any further.

Bar 18 is slidingly arranged within chamber 11 obtained in the support body 24 suitable for seating further component elements of the device that shall be described hereinafter.

Said support body 24 is closed at the bottom by a cover 70 defined by a base or bottom 70′ from the top front whereof a collar 70″ develops, according to a vertical direction and along the perimeter thereof.

With particular reference to FIG. 9, cover 70 partly circumscribes bar 18 which may be made torsionally integral to said cover by approaching two portions 71 and 71′ not matching of the same cover by the tightening action of a screw 72 or an equivalent means suitable for performing the same function.

The support body 24 is constrained to a plate 27 for connecting the tool holder device to the structure (not shown in the figure) of the shearing machine.

According to the alternative embodiment of the figures, the support body 24 exhibits two further chambers 23 suitable for seating and allowing the sliding of a first piston 30 and of a second piston 32 stabilised to the base or bottom 70′ of cover 70 by screws 74 or other known removable constraining means.

The first piston 30 and the second piston 32 preferably are of the anti-rotation type with pneumatic actuation (sliding relative to bushings 31 and 31′ and they may be provided with an optional elastic element, defined by a helical spring 36 with the function of allowing an elastic return.

The bottom end of bar 18 extends in an appendix 42 shaped as an “L” and provided with one or more holes 44 suitable for allowing the constraint and the support of the of the elastically deformable arm 16 the blade or knife 12 is connected to.

The top end portion of bar 18 protruding from the support body 24 is inserted in a flanged bushing 76 that exhibits a through crosswise hole (78) suitable for allowing the insertion of a pin (80) that engages with a corresponding crosswise hole made in the top end of bar 18.

Said pin 80 has the function of making bar 18 and the flanged bushing 76 integral for the function that shall be detailed hereinafter.

An appendix 82 develops starting from the outer side surface of the flanged bushing 76.

An adjustment bushing 84, also flanged and stabilised to the top front of the support body 24 is fitted on top of the flanged bushing 76 by screws 88 or other known constraining means.

An angular opening or slot 90 is made along the outer side surface of the flange of the adjustment bushing 84 wherein appendix 82 of the flanged bushing 76 engages; an angular graduated scale (not shown in the figures) is provided on the top front of the flange of the adjustment bushing 84, at the opening or slot 90.

A vertical graduated scale is made on the outer side surface of the cylindrical body of the adjustment bushing 84; said further vertical graduated scale has the function of allowing the adjustment described below by a traditional adjustment means defined by a vernier scale 62.

The support body 24 exhibits at least one crosswise hole 92 (in the preferred alternative embodiment such holes are two) wherein there is inserted a dowel or pin 94 that engages with the flanged bushing 76 consequently causing a rotational stiffness of bar 18 relative to the support body 24; this in addition to the tightening action of cover 70 fitted on the support body 24.

The manual loosening of dowels or pins 94 and the release of the same relative to the flanged bushing 76 implies the temporary elimination of the rotational stiffness constraint of bar 18 relative to the support body 24.

In this way, acting on appendix 82 of the flanged bushing 76, an angular rotation of the same flanged bushing and thus of bar 18 is obtained, which is integral to said bushing through pin 80; the graduated scale provided on the outer surface of the flange of the adjustment bushing 84 allows the precise adjustment of the angular position of bar 18 based on the specific requirements of angular positioning of blade 12.

It should be noted that in the condition of free bar 18, made by loosening the tightening screw 72 of cover 70, it does not rotate idly but its rotation is obtained by acting on appendix 82 of the flanged bushing 76.

By manually acting on the vernier scale 62 by a wrench or other known means, the vertical (axial) position of bar 18 is precisely adjusted so as to allow the adjustment of the down stroke of the shearing tool or blade 12.

Such down movement is obtained, as explained above with reference to the preferred embodiment, by pistons 30 and 32.

The adjustment of the angular position and of the axial position of bar 18 may be obtained automatically by electrical linear stepping motors.

As can be noticed from the above, the advantages achieved by the device of the invention are clear.

The tool holder device for shearing machines of the present invention advantageously allows easily adjusting the shearing angle preventing the risk of occurrence of clearances that would cause errors on the material being processed and thus a consequent poor shearing quality.

A further advantage is the fact that in the tool holder device of the present invention, the adjustment of the down stroke of the tool is not performed through the pistons which, in the traditional solutions, control the bar movement, but directly acting on the bar that is totally independent of said pistons.

A further advantage is represented by the fact that in order to adjust the shearing angle it is not necessary to replace or add components, but it is sufficient to adjust the angular position of the bar using the reference of the angular graduated scale provided on the adjustment bushing.

A further advantage is represented by the fact that the specific embodiment of the cover fitted on the support body allows both preventing the problem of the bar rotation and, through the loosening of the tightening imposed by the same cover on the bar, allowing a quick and easy angular variation of the bar according to the specific processing requirements.

A further advantage is that since the tool holder device of the invention does not require additional or interchangeable components for adjusting the shearing angle, it implies a reduction of processing and production costs.

A further advantage is that the device of the invention is totally interchangeable with the traditional tool holder devices, without implying the need of replacements of shearing machines.

Although the invention has been described hereinbefore with particular reference to an embodiment thereof made by way of a non-limiting example only, several changes and variations will appear clearly to a man skilled in the art in the light of the above description. The present invention therefore includes all the changes and versions that fall within the spirit and scope of the following claims.

1. A tool holder device (10, 10′) for shearing machines, especially of the longitudinal type, suitable for processing on paper, cardboard, plastic films, various laminates, aluminium, fabric, non woven, fibreglass, carbon fibre and the like, comprising a blade holder head provided with a preferably circular blade (12), partially protected by a casing (14) and rotatably connected to an elastically deformable arm (16) and to a bar (18) sliding according to a vertical direction, a further protection element for the same blade defined by a shaped plate (20) provided with a through opening (22), at least one piston (30, 32) for the up/down movement of the blade holder, with said bar (18) and said at least one piston (30, 32) arranged and moved in a chamber (23) of a support body (24), a vernier scale (62) arranged at the top of a flanged adjustment bushing (54) and stabilised to the top front of the support body (24), provided with a graduated scale along an outer vertical portion of the cylindrical surface of said adjustment bushing, the tool holder device characterised in that it comprises a cover (26, 70) placed for closing the bottom portion of the support body (24), axially sliding relative to the same support body and formed by two portions (15, 15′, 71, 71′) not matching and suitable for partly circumscribing the bar (18) and torsionally tightening it by a screw (28, 72), said cover comprising a base or bottom (26′, 70′) from the top front whereof a collar (26″, 70″) develops according to a vertical direction, which externally circumscribes a bottom portion of the support body (24).

2. The tool holder device according to claim 1, characterised in that the cover (26) comprises a lever (25) fixed to the bar (18), partly engaged in a pocket (21) obtained on the front surface of the same cover and suitable for allowing an adjustment of the shearing angle.

3. The tool holder device according to claim 1, characterised in that it comprises a flanged bushing (76) fitted on the portion of the bar (18) protruding from the top front of the support body (24) and from at least one dowel (94) arranged in a hole (92) made in crosswise direction into the support body (24) and suitable for engaging with said flanged bushing, the flanged bushing (76) which exhibits a through crosswise hole (78) suitable for allowing the insertion of a pin (80) engaged with a corresponding crosswise hole made in the top end of the bar (18), said flanged bushing (76) cooperating with the cover (70) for allowing the adjustment of the tool shearing angle.

4. The tool holder device according to claim 3, characterised in that it comprises an adjustment bushing (84) flanged and fitted on the flanged bushing (76), stabilised to the top front of the support body (24) and provided with a graduated scale along a vertical portion of the outer surface for adjusting the stroke of the bar (18) by the vernier scale (62) arranged at the top and axially to the same adjustment bushing.

5. The tool holder device according to claim 3, characterised in that the flanged bushing (76) is provided with an appendix (82) formed starting from the outer side surface of the flange of the flanged bushing (76) and engaged with an angular opening or slot (90) made along the outer side surface of the flange of the adjustment bushing (84).

6. The tool holder device according to claim 1, characterised in that the pistons (30, 32) for the up and down movement of the blade holder are two, with pneumatic actuation, sliding relative to bushings (31) and stabilised to the base or bottom of the cover (26, 70).

7. The tool holder device according to claim 1, characterised in that the up and down movement of the blade holder head provided with the blade (12) is carried out automatically by electrical linear stepping motors.

8. The tool holder device according to claim 4, characterised in that the adjustment of the shearing angle and of the down stroke of the blade (12) are carried out automatically by motor-driven actuators.
